(19) United States
(12) Patent Application Publication
(10) Pub. No.: US 2013/0161476 A1
(43) Pub. Date: Jun. 27, 2013

(54) FIXING APPARATUS FOR FANS

(71) Applicants: XIAO-FENG MA, Shenzhen City (CN); LEI LIU, Shenzhen City (CN)

(72) Inventors: XIAO-FENG MA, Shenzhen City (CN); LEI LIU, Shenzhen City (CN)

(73) Assignees: HON HAI PRECISION INDUSTRY CO., LTD., Tu-Cheng (TW); HONG FU JIN PRECISION INDUSTRY (SHENZHEN) CO., LTD., Shenzhen City (CN)

(21) Appl. No.: 13/455,148

(22) Filed: Apr. 25, 2012

(30) Foreign Application Priority Data
Dec. 23, 2011 (CN) 201110437259.9

(51) Int. Cl. F16M 13/00

(52) U.S. Cl. 248/674

(57) ABSTRACT

A fixing apparatus includes a base, a fixing wall perpendicularly extending up from the base, and a fixing member. Two opposite slots are defined in the fixing wall. The fixing member includes a stop plate, and two arms perpendicularly extending from opposite ends of the stop plate to extend through the slots of the fixing wall. A number of poles protrude from inner surfaces of fixing wall and the stop plate, for engaging in corresponding latching holes of opposite ends of a fan. A number of protrusions spaced in a direction perpendicular to the stop plate are formed on each arm. When the fixing member is slid towards the fixing wall, two of the protrusions respectively extend through the slots and engage with a side of the fixing wall facing away from the stop plate, for sandwiching the fan between the stop plate and the fixing wall.

### BACKGROUND

1. Technical Field

The present disclosure relates to an apparatus for fixing in place fans with different sizes.

2. Description of Related Art

A fan can be mounted in a computer by a fixing apparatus. The fan usually includes two opposite side plates and the depth or thickness between the side plates of different fans is not always the same. However, a standard fixing apparatus cannot fix different fans with different thicknesses.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a partially exploded, isometric view of an exemplary embodiment of a fixing apparatus together with a number of fans, wherein the fixing apparatus includes a fixing member.

FIG. 2 is an enlarged view of the fixing member of FIG. 1 from another perspective.

FIG. 3 is an assembled, isometric view of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

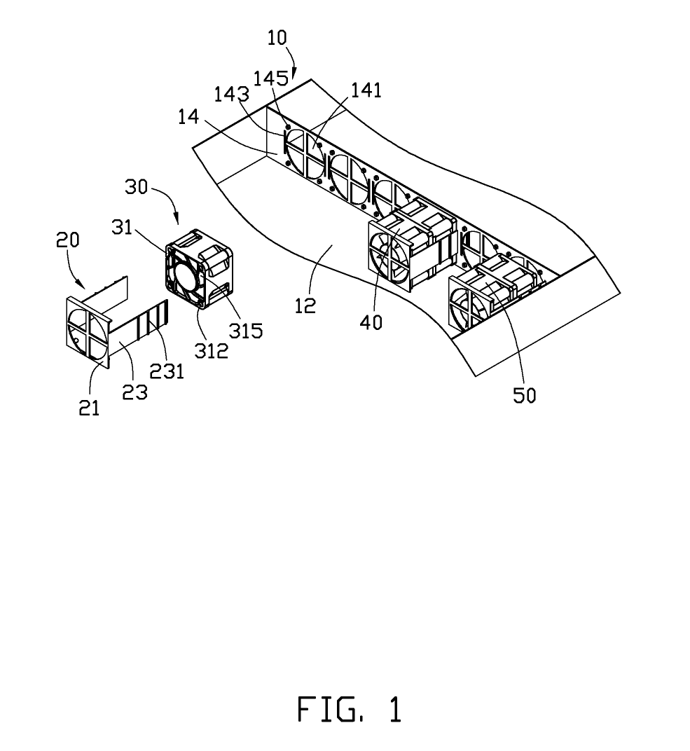

FIG. 1 shows an exemplary embodiment of a fixing apparatus which is provided to fix fans with different thicknesses. The fixing apparatus includes a bracket 10 and a plurality of fixing members 20.

The bracket 10 includes a base 12 and a fixing wall 14 substantially perpendicularly extending up from the base 12. A plurality of first vents 141 is defined in the fixing wall 14 and spaced in a longitudinal direction of the fixing wall 14. Two slots 143 substantially perpendicular to the base 12 are defined in the fixing wall 14 beside opposite ends of each first vent 141. Four first poles 145 protrude from a side of the fixing wall 14 around each first vent 141.

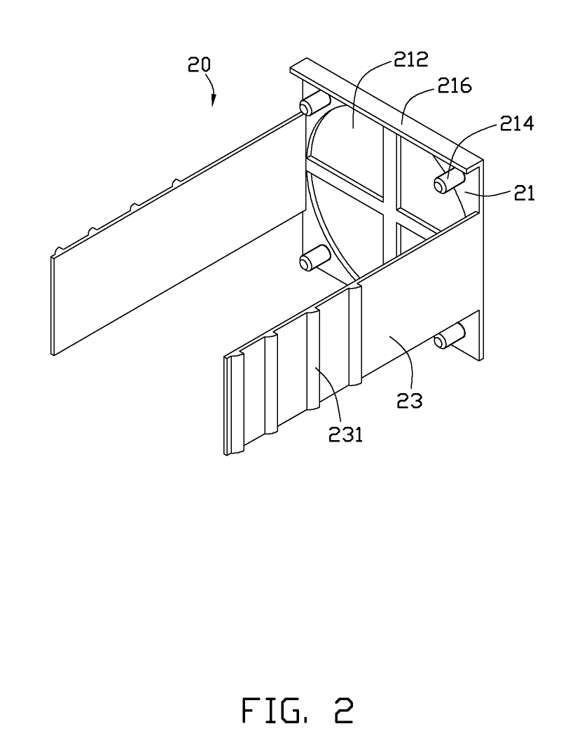

Referring to FIG. 2, each fixing member 20 includes a stop plate 21 and two arms 23 substantially perpendicularly extending from opposite ends of the stop plate 21. A second vent 212 is defined in the stop plate 21. Four second poles 214 protrude from a side of the stop plate 21 facing the arms 23, and around the second vent 212. A flange 216 extends towards the arms 23 from the top of the stop plate 21. A plurality of elongated protrusions 231 is formed on an outer surface of each arm 21. The protrusions 231 are parallel to the stop plate 21, and spaced in a direction perpendicular to the stop plate 21.

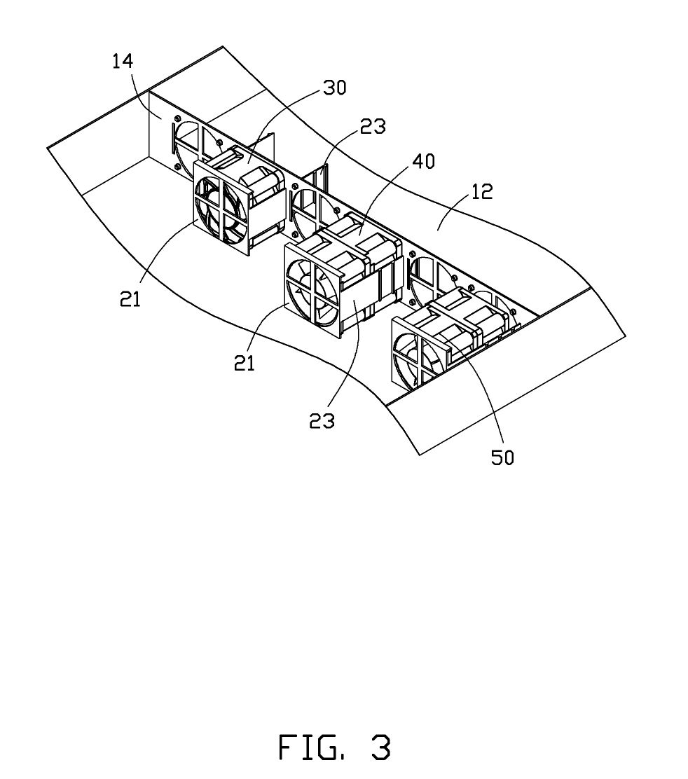

Referring to FIGS. 1 and 3, a first fan 30 includes two opposite side plates 31. A vent 315 is defined in a middle of each side plate 31. Four latching holes 312 are defined in each side plate 31 around the corresponding vent 315.

To fix the first fan 30 to the fixing apparatus, the first fan 30 is placed on the base 12, to allow the vent 315 to align with one of the first vents 141, and to allow the latching holes 312 of one of the side plates 31 to respectively align with the first poles 145 around the first vent 141. The first fan 30 is slid towards the fixing wall 14 until the corresponding side plate 31 abuts against the fixing wall 14, and the first poles 145 respectively engage in the latching holes 312 of the corresponding side plate 31. The arms 23 of one of the fixing members 20 respectively contact opposite ends of the first fan 30. The fixing member 20 is slid towards the fixing wall 14, distal ends of the arms 23 respectively extend through two corresponding slots 143 at opposite ends of the first fan 30. When the second poles 214 respectively engage in the latching holes 312 of the other side plate 31, and the stop plate 21 abuts against the other side plate 31, two of the protrusions 231 of the arms 23 exactly extend through the corresponding slots 143 and engage with the other side of the fixing wall 14 facing away from the first fan 30. Thereby, the first fan 30 is sandwiched between stop plate 21 and the fixing wall 14. The flange 216 engages with the top of the first fan 30.

Because there is a plurality of spaced protrusions 231 formed on the outer surface of each arm 23, the fixing member 20 and the bracket 10 can fix fans with different thicknesses. In FIG. 3, to fix a second fan 40 and a third fan 50, the fixing members 20 are slid towards the fixing wall 14. Two corresponding protrusions 231 of the arms 23 of each fixing member 20 extend through two slots 143 and engage with the other side of the fixing wall 14 facing away from the second fan 40 and the third fan 50, to sandwich the second fan 40 and the third fan 50 between the stop plates 21 and the fixing wall 14.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A fixing apparatus for fans, comprising:
a base for supporting a fan;
a fixing wall perpendicularly extending up from the base, wherein two opposite slots are defined in the fixing wall, and a plurality of first poles protrudes from a side of the fixing wall, for engaging in corresponding latching holes of a side plate of the fan;
a fixing member comprising a stop plate, and two arms perpendicularly extending from opposite ends of the stop plate to extend through the slots of the fixing wall, wherein a plurality of second poles protrudes from a side of the stop plate facing the arms, for engaging in corresponding latching holes of an opposite side plate of the fan, and a plurality of protrusions spaced in a direction perpendicular to the stop plate is formed on each arm, when the fixing member is slid towards the fixing wall, two of the protrusions of the arms respectively extend through the slots and engage with an opposite side of the fixing wall facing away from the stop plate, for sandwiching the fan between the stop plate and the fixing wall.

2. The fixing apparatus of claim 1, wherein a first vent is defined in the fixing wall surrounded by the first poles, for aligning with the fan, the slots are respectively arranged beside opposite ends of the first vent.

3. The fixing apparatus of claim 2, wherein the slots and the protrusions are elongated and perpendicular to the base.

4. The fixing apparatus of claim 3, wherein the protrusions are formed on an outer surface of each arm.

5. The fixing apparatus of claim 2, wherein a second vent is defined in the stop plate surrounded by second poles, for aligning with the fan.

6. The fixing apparatus of claim 1, wherein a flange extends towards the fixing wall from a top of the stop plate, for engaging with a top of the fan.
